(19) United States
(12) Patent Application Publication
(10) Pub. No.: US 2009/0119835 A1
(43) Pub. Date: May 14, 2009

(54) Apparatus for Transportation of a Disabled Person in Standing Position

(76) Inventor: Gunnar Liljedahl, Lulea (SE)

Correspondence Address: DICKSTEIN SHAPIRO LLP, 1825 EYE STREET NW, Washington, DC, 20006-5403, US

(21) Appl. No.: 11/795,960

(22) PCT Filed: Feb. 15, 2006
(86) PCT No.: PCT/SE2006/000205

§ 371 Date: Jul. 25, 2007

(30) Foreign Application Priority Data
Feb. 25, 2005 (SE) 0500438-7

(51) Int. Cl. A61G 7/10; A61G 1/00

(52) U.S. Cl. 5/87.1; 5/89.1

(57) ABSTRACT

Apparatus for transportation of a disabled person in standing position by which apparatus the person is able by his own strength to rise himself from a sitting position to a standing position, including a wheeled base (1) in the form of an U-shaped frame provided with a footrest (3) and a post (2), which supports at least one support frame (5). The support frame (5) comprises two legs (6a, 6b), which each at its end support through locking means (7a, 7b) an arm (8a, 8b), which is fixed in the longitudinal direction but pivotally arranged in the locking means, and that each arm (8a, 8b) has a supporting means (9) arranged in such a way that, when a person is standing, it can be pivoted behind the person, so that the person will be enclosed by the post (2), the support frame (5), the legs (8a, 8b), and the supporting means (9).

### FIELD OF THE INVENTION

The present invention relates to an apparatus for transportation of a disabled person in standing position by which apparatus the person is able by his own strength to rise himself from a sitting position to a standing position, including a wheeled base in the form of an U-shaped frame provided with a footrest and a post, which supports at least one support frame.

### PRIOR ART

Apparatuses for transportation of a person in standing position are known. By the Swedish patent SE-511982, for instance, is previously known an aid apparatus for raising a disabled person from a sitting position to a standing position. This aid apparatus comprises a wheeled base in the form of an U-shaped frame having a post, which supports a lifting means, to which a lifting sling can be attached surrounding at least partly the body of a person, which lifting means comprises a lifting arm construction having a free end which can be raised or lowered relatively the base and supports the lifting sling.

Even if it is possible with the assistance of the above-mentioned aid apparatus to transport a disabled person in standing position, he has no fixed support against his back and in the lateral direction but is only strapped by the lifting sling, which results in that the person during transportation easily swing in a reciprocating motion and laterally. The transportation of the person is therefore very unstable and can only be done a short distance.

The object of the invention is to achieve an apparatus by which a person in a safe and stable way can be transported in standing position.

This object is achieved by an apparatus having the characterizing features set forth in the appended claims.

### BRIEF DESCRIPTION OF THE DRAWINGS

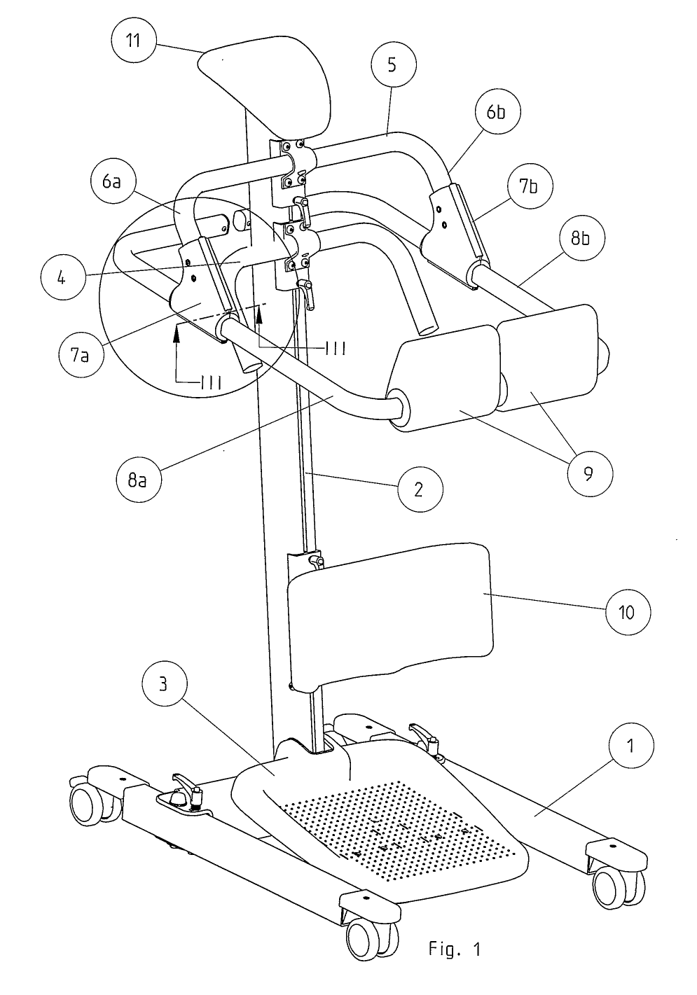

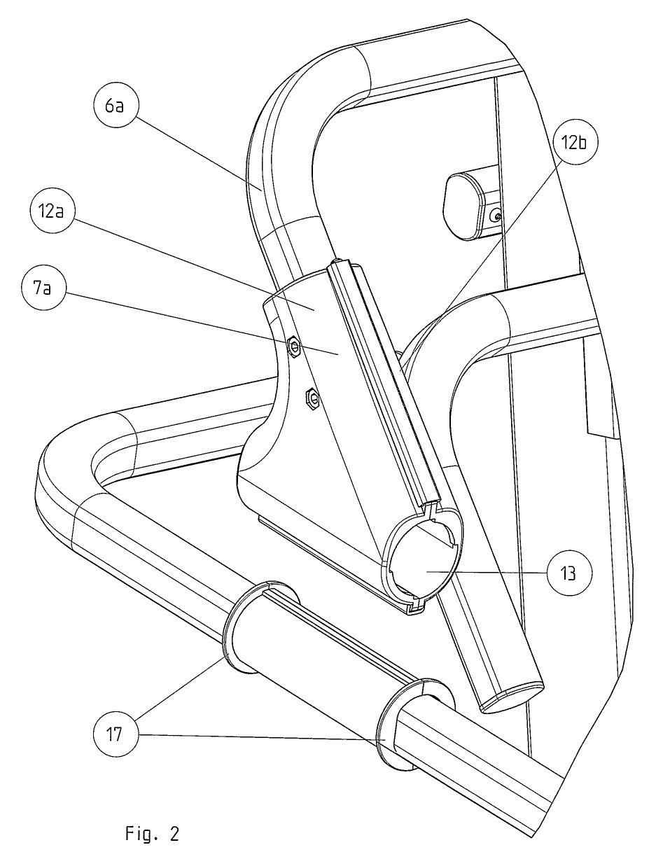

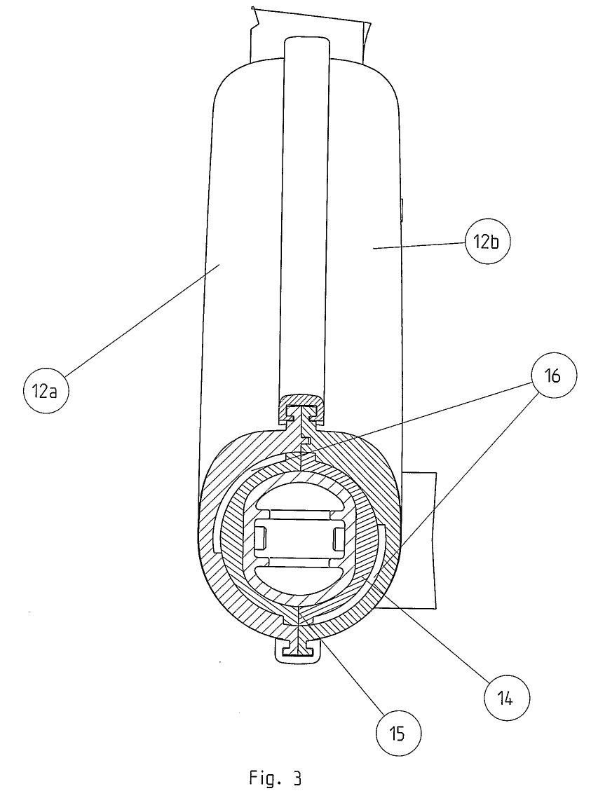

The invention is further disclosed with the reference to the enclosed drawings, on which FIG. 1 is a perspective view of an apparatus according to the invention, FIG. 2 is an enlarged, exploded view of the locking means shown within the ring in FIG. 1, and FIG. 3 is a broken, sectional end view taken along the line III-III in FIG. 1 of the locking means.

### DESCRIPTION OF EMBODIMENTS

The apparatus according to the invention shown in FIG. 1 comprises a foot rest 3 having a wheeled base 1 in the form of a U-shaped frame with a post 2. The post 2 supports, in the shown embodiment, a handle frame 4, a support frame 5, a support plate 10 and a cushion 11. The handle frame 4, the support frame 5 and the support plate 10 are arranged vertically adjustable on the post 2 for adaptation to the person to be transported.

The support frame 5 comprises two, downwardly directed legs 6a, 6b, which at each of their ends, through locking means 7a, 7b, support horizontally arranged arms 8a, 8b, fixedly arranged in longitudinal direction but pivotally arranged in the locking means. The arms 8a, 8b support each at their ends supporting means 9 adapted to be placed behind the person, when the person is standing on the foot rest 3, preferably below the curve of the back and behind the buttocks. Each arm 8a, 8b is preferably at its both ends bend 900 in the same direction, so that they have a general U-shape to form on one hand a handle for turning the respective arms, and on the other hand a bracket for the supporting means 9.

As shown in FIG. 2 each locking means 7a, 7b comprise two parts 12a, 12b which in the ensemble condition form on one hand a through going bore 13, in which the arms 8a, 8b is adapted to be supported fixed in the longitudinal direction but pivotal, and on the other hand a blind bore in which the ends of the legs 6a and 6b, respectively, are arranged to be rigidly fastened.

In a preferred embodiment, as shown in FIG. 3, the locking means 7a, 7b comprises a two part sleeve 14 adapted to be fixed in the longitudinal direction on the arm 8a and 8b, respectively. The two part sleeve 14 has two diametrically opposed longitudinal protrusions 15 adapted to be turned between two end positions in grooves 16, respectively, arranged in the two parts 12a, 12b of the locking means, in one end position the supporting means 9 is turned up in a general vertical direction and in the other end position the supporting means 9 is turned down in a general horizontal behind the standing person. In one of the parts 12a the groove 16 extends in an angle of preferably 900 from 12 o'clock to 9 o'clock, and in the other part 12b a corresponding angle from 6 o'clock to 3 o'clock. The two part sleeve 14 is at its end provided with a rest 17, whereby the arms 8a, 8b can not move in the longitudinal direction of the bore 13 of the locking means 7a, 7b, but can be pivoted.

When one wishes to move a person, not shown, standing with the assistance of the apparatus according to the invention, an assistant turns by means of the handle the arm 8a 8b, respectively, with attached supporting means 9 90°, preferably in such a way that the supporting means is pivoted vertically, whereby an opening is formed between the supporting means 9 large enough to make room for the person. The person grips the handle frame 4 in sitting position with his feet on the foot rest 3 and the lower legs/knees rest against the support plate 10, whereby the person by his on strength can pull himself up to standing position. Once the person is in standing position the assistant pivot the arms 8a,8b in the opposite direction to the above stated, so that the support means are placed generally horizontally behind the person, preferably below the curve of the back and particularly against the buttocks of the person. In this way the person is supported both in the longitudinal direction as well as laterally and can be transported in a safe manner even during long distances. The person can rest against the cushion 11 on the post 2, if necessary.

1. Apparatus for transportation of a disabled person in standing position by which apparatus the person is able by his own strength to rise himself from a sitting position to a standing position, including a wheeled base (1) in the form of an U-shaped frame provided with a footrest (3) and a post (2), which supports at least one support frame (5), characterized in that the support frame (5) comprises two legs (6a, 6b), which each at its end support through locking means (7a, 7b) an arm (8a, 8b), which is fixed in the longitudinal direction but pivotally arranged in the locking means, and that each arm (8a, 8b) has a supporting means (9) arranged in such a way that, when a person is standing, it can be pivoted behind the person, so that the person will be enclosed by the post (2), the support frame (5), the legs (8a, 8b), and the supporting means (9).

2. Apparatus according to claim 1, characterized in that the supporting means (9) are arranged to be placed below the curve of the back of the person standing.

3. Apparatus according to claim 1, characterized in that the locking means (7a, 7b) comprises a sleeve (14) adapted to be fixed in the longitudinal direction on the arm (8a, 8b), respectively, which sleeve is provided with two diametrically opposed protrusions adapted to be pivoted between two end positions, in one end position the supporting means (9) being turned up in a general vertical direction and in the other end position the supporting means (9) being turned down in a general horizontal direction behind the person.

4. Apparatus according to claim 1, characterized in that the post (2) also supports a handle frame (4).

5. Apparatus according to claim 4, characterized in that the handle frame (4), the support frame (5), and a support plate (10) supported by the post, all are arranged vertically adjustable on the post (2).
